(19) United States
(12) Patent Application Publication
(10) Pub. No.: US 2025/0200301 A1
(43) Pub. Date: Jun. 19, 2025

(54) LEARNING TO COMPRESS PROMPT IN NATURAL LANGUAGE FORMATS

(71) Applicant: SAMSUNG ELECTRONICS CO., LTD., Suwon-si (KR)

(72) Inventors: Yu-Neng CHUANG, Houston, TX (US); Tianwei XING, Santa Clara, CA (US); Xun CHEN, Fremont, CA (US)

(73) Assignee: SAMSUNG ELECTRONICS CO., LTD., Suwon-si (KR)

(21) Appl. No.: 18/977,049

(22) Filed: Dec. 11, 2024

Related U.S. Application Data
(60) Provisional application No. 63/609,707, filed on Dec. 13, 2023.

(51) Int. Cl. G06F 40/40; G06F 16/242; G06F 40/284; G06F 40/30; G06N 3/043; G06N 3/0475; G06N 3/092

(52) U.S. Cl. CPC G06F 40/40; G06F 16/243; G06F 40/284; G06F 40/30; G06N 3/043; G06N 3/0475; G06N 3/092

(57) ABSTRACT

Methods, systems, and apparatuses for performing natural language prompt compression, the method being performed by an electronic device and including: obtaining a prompt for an artificial intelligence (AI) inference model, wherein the prompt corresponds to a first plurality of tokens; providing the prompt as an input to an AI compression model; and obtaining a compressed prompt based on an output of the AI compression model, wherein the compressed prompt corresponds to a second plurality of tokens which is smaller than the first plurality of tokens, and wherein the prompt and the compressed prompt are expressed using natural language.

### CROSS-REFERENCE TO RELATED APPLICATION(S)

This application is based on and claims priority under 35 U.S.C. § 119 to U.S. Provisional Patent Application No. 63/609,707, filed on Dec. 13, 2023, in the U.S. Patent & Trademark Office, the disclosure of which is incorporated by reference herein in its entirety.

### BACKGROUND

### 1. Field

The disclosure relates to natural language processing, and more particularly to natural language prompt compression for large language models.

### 2. Description of Related Art

Artificial intelligence (AI) models such as large language models (LLMs) have demonstrated substantial proficiency across a variety of natural language processing tasks. Despite their significant potential and broad adoption, LLMs may be limited by their constrained context length, which may impair their ability to process lengthy documents and may affect their efficiency during inference. Deploying LLMs capable of handling extended lengths may enable users to process large-scale datasets efficiently with reduced budgets.

To address this issue, some approaches have focused on compressing long prompt contexts into concise soft prompts. These approaches may involve transforming the original extensive prompt into a more manageable series of short-length soft prompt tokens. Generally, compression-oriented soft prompts may be learned with the guarantee of semantics through self-information, instruction finetuning, and the performance alignment using knowledge distillation. However, it may be difficult to transfer soft prompts across different LLMs, which implies that well-trained soft prompts can only be effectively adapted to the specific LLMs for which they were designed. Accordingly, there is a need for a process for performing prompt compression that effectively maintains both transferability and utility of the compressed prompts.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method of performing natural language prompt compression, the method includes: obtaining a prompt for an artificial intelligence (AI) inference model, wherein the prompt corresponds to a first plurality of tokens; providing the prompt as an input to an AI compression model; and obtaining a compressed prompt based on an output of the AI compression model, wherein the compressed prompt corresponds to a second plurality of tokens which is smaller than the first plurality of tokens, and wherein the prompt and the compressed prompt are expressed using natural language.

The method may further include obtaining a first embedding representing the prompt and a second embedding representing the compressed prompt; determining a semantic loss between the first embedding and the second embedding; and training the AI compression model based on the semantic loss.

The method may further include appending a question to the compressed prompt to obtain an appended compressed prompt; and providing the appended compressed prompt to the AI inference model to obtain a first inference result.

The method may further include appending the question to the prompt to obtain an appended prompt; providing the appended prompt to the AI inference model to obtain a second inference result; determining a reward score based on the first inference result and the second inference result; and training the AI compression model based on the reward score.

Parameters of the AI inference model are frozen during the training of the AI compression model.

The AI compression model and the AI inference model may be large language models (LLMs).

The prompt may be a chain of thought prompt including a plurality of questions and a corresponding plurality of answers.

A number of the second plurality of tokens may be less than a maximum number of tokens for the AI compression model.

In accordance with an aspect of the disclosure, an electronic device for performing natural language prompt compression includes: at least one memory configured to store instructions; and at least one processor configured to execute the instructions to: obtain a prompt for an artificial intelligence (AI) inference model, wherein the prompt corresponds to a first plurality of tokens, provide the prompt as an input to an AI compression model, and obtain a compressed prompt based on an output of the AI compression model, wherein the compressed prompt corresponds to a second plurality of tokens which is smaller than the first plurality of tokens, and wherein the prompt and the compressed prompt are expressed using natural language.

The at least one processor may be further configured to execute the instructions to: obtain a first embedding representing the prompt and a second embedding representing the compressed prompt; determine a semantic loss between the first embedding and the second embedding; and train the AI compression model based on the semantic loss.

The at least one processor may be further configured to execute the instructions to: append a question to the compressed prompt to obtain an appended compressed prompt; and provide the appended compressed prompt to the AI inference model to obtain a first inference result.

The at least one processor may be further configured to execute the instructions to: append the question to the prompt to obtain an appended prompt; provide the appended prompt to the AI inference model to obtain a second inference result; determine a reward score based on the first inference result and the second inference result; and train the AI compression model based on the reward score.

Parameters of the AI inference model may be frozen during the training of the AI compression model.

The AI compression model and the AI inference model may be large language models (LLMs).

The prompt may be a chain of thought prompt including a plurality of questions and a corresponding plurality of answers.

A number of the second plurality of tokens may be less than a maximum number of tokens for the AI compression model.

In accordance with an aspect of the disclosure, a non-transitory computer-readable medium storing instructions which, when executed by at least one processor of a device for performing natural language prompt compression, cause the device to: obtain a prompt for an artificial intelligence (AI) inference model, wherein the prompt corresponds to a first plurality of tokens; provide the prompt as an input to an AI compression model; and obtain a compressed prompt based on an output of the AI compression model; wherein the compressed prompt corresponds to a second plurality of tokens which is smaller than the first plurality of tokens, and wherein the prompt and the compressed prompt are expressed using natural language.

The instructions may further cause the device to: obtain a first embedding representing the prompt and a second embedding representing the compressed prompt; determine a semantic loss between the first embedding and the second embedding; and train the AI compression model based on the semantic loss.

The instructions may further cause the device to: append a question to the compressed prompt to obtain an appended compressed prompt; and provide the appended compressed prompt to the AI inference model to obtain a first inference result.

The instructions may further cause the device to: append the question to the prompt to obtain an appended prompt; provide the appended prompt to the AI inference model to obtain a second inference result; determine a reward score based on the first inference result and the second inference result; and train the AI compression model based on the reward score.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of natural language prompt compression, according to embodiments;

FIG. 2 is a diagram showing an example of an electronic device for performing natural language prompt compression using an artificial intelligence prompt compression model, according to embodiments;

FIG. 3 is a diagram showing a training environment for training a prompt compression model, according to embodiments;

FIG. 4 is a flowchart illustrating a process for training a prompt compression model, according to embodiments;

FIGS. 5A and 5B are flowcharts illustrating processes for training and using a prompt compression model, according to embodiments;

FIG. 6 is a block diagram of an electronic device according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As discussed above, artificial intelligence (AI) models such as large language models (LLMs) may be used to perform natural language (NL) processing tasks. However due to limitations such as constrained context lengths and finite processing capacity, it may be beneficial to reduce a size of prompts provided to these LLMs in order to improve processing efficiency.

Some approaches to reducing prompt length may involve compressing relatively long NL prompts into more manageable soft prompts, which may be a series of short-length soft prompt tokens. However, because these soft prompts are not in a NL format, it may be difficult to transfer them across multiple different models. For example, soft prompts that are acceptable as input for a certain LLM may show reduced utility such as unacceptable results when provided as inputs for different LLMs.

In order to maintain transferability, it may be beneficial to maintain compressed prompts in an NL format instead of a soft prompt format. However, unlike soft prompts, which may be directly optimized with a fixed length, it may be difficult to generate compressed NL prompts for several reasons. For example, NL prompts may generally be incompatible with back-propagation, because a gradient may not be propagated backward to a discrete raw text. In addition, it may be difficult to impose strict length constraints for compressed NL prompts, because overly stringent limitations on generation length may lead to performance degradation. Thus, it is nontrivial to compress lengthy original NL prompts into shorter compressed NL prompts.

Embodiments may provide a prompt compression model which may be used to compress a relatively long original prompt into a relatively short compressed prompt, and processes for training and using such a prompt compression model. Embodiments may include obtaining an original prompt and providing the original prompt to a prompt compression model to obtain a compressed prompt. According to embodiments, the compressed prompt may correspond to fewer tokens than the original prompt. Embodiments may further include appending a question to the compressed prompt to obtain an appended compressed prompt, and providing the compressed prompt as input to a downstream inference model, for example an LLM, which may be configured to output an answer corresponding to the compressed prompt.

According to some embodiments, the original prompt may be obtained from a training dataset, and the compressed prompt may be used to train the prompt compression model. For example, the original prompt may be provided to the inference model to obtain an answer corresponding to the original prompt, and the compressed prompt may be provided to the inference model to obtain an answer corresponding to the compressed prompt. In addition, embodiments may further include determining a semantic loss based on a similarity between a first embedding representing the original prompt and a second embedding representing the compressed prompt, determining a reward score based on a similarity between the answer corresponding to the original prompt and the answer to the compressed prompt, and updating parameters such as weights and thresholds of the prompt compression model based on the semantic loss and the reward score.

In some embodiments, both the original prompt and the compressed prompt may be in an NL format. For example, the prompt compression model may be an LLM which may be constrained by a maximum number of tokens for the compressed prompt. Accordingly, the prompt compression model and/or the compressed prompt may be transferrable to inference models which are different than the inference model that is used to train the prompt compression model, for example different LLMs or different types of inference models.

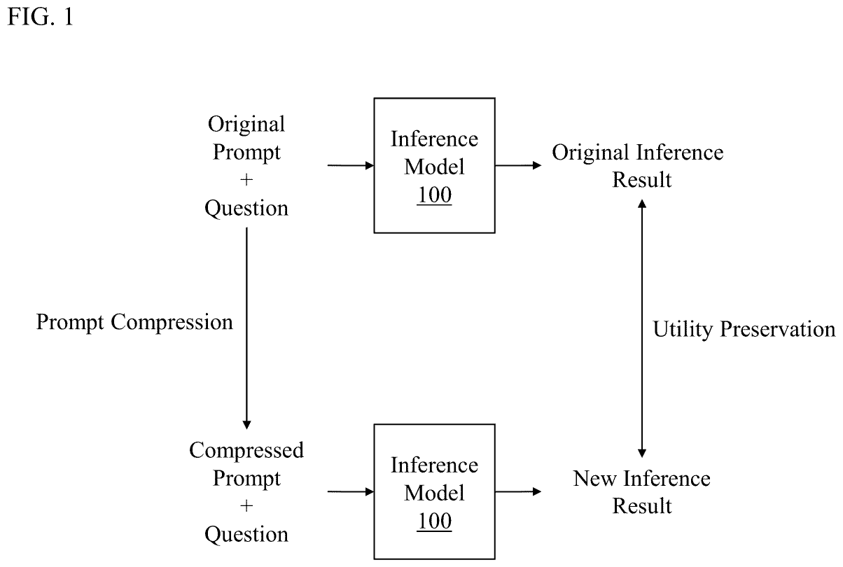

FIG. 1 is a diagram showing a general overview of an NL prompt compression, according to embodiments.

As shown in FIG. 1, an inference model 100, which may be for example an LLM, may receive an original prompt appended to a question as input, and may generate an original inference result based on the original prompt and the question. However, as discussed above, it may be beneficial to reduce a size of prompts provided to the inference model 100 in order to improve processing efficiency. Therefore, prompt compression may be performed on the original prompt to obtain a compressed prompt. According to embodiments, the compressed prompt may be smaller than the original prompt. For example, in some embodiments, the original prompt may correspond to, or may be represented using, a first number of tokens, and the compressed prompt may correspond to, or may be represented using, a second number of tokens which is less than the first number of tokens, but embodiments are not limited thereto.

After the compressed prompt is obtained, it may be appended to the question and provided to the inference model 100 as input, and a new inference result may be obtained. According to embodiments, if the prompt compression is performed properly, the new inference result may be similar or identical to the original inference result.

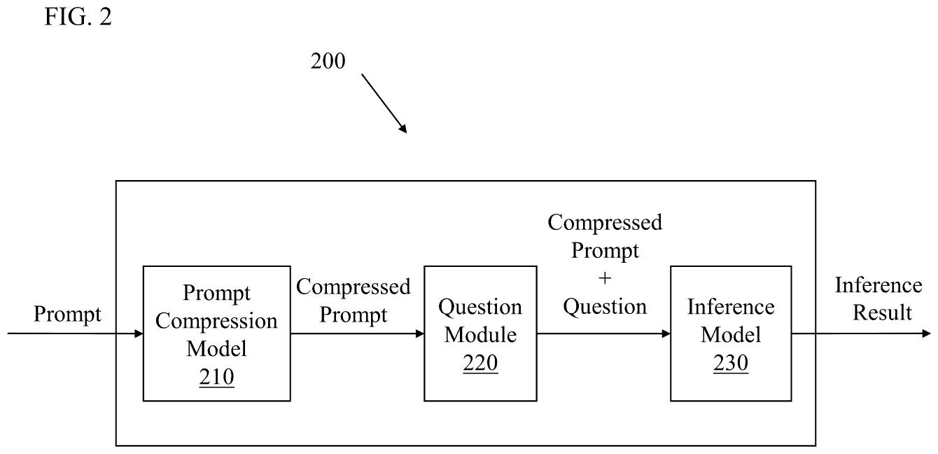

FIG. 2 is a diagram showing an example of an electronic device for performing NL prompt compression using an artificial intelligence prompt compression model, according to embodiments. As shown in FIG. 2, the electronic device 200 may include a prompt compression model 210, a question module 220, and an inference model 230.

According to embodiments prompt compression model 210 may be an artificial intelligence (AI) model which may be trained to receive an original prompt as input, and to output a compressed prompt. For example, in some embodiments the prompt compression model 210 may be a large language model (LLM), but embodiments are not limited thereto. In embodiments, both the original prompt and the compressed prompt may be expressed in an NL format, e.g., in a natural human language. According to embodiments, when the original prompt is tokenized into a first plurality of tokens and the compressed prompt is tokenized into a second plurality of tokens, the first plurality of tokens may be longer than the second plurality of tokens. Accordingly, when the compressed prompt is provided as input to another model (e.g., the inference model 230), the compressed prompt may be processed more efficiently than the original prompt.

The question module 220 may receive a prompt (e.g., the original prompt or the compressed prompt) and may append thereto a question corresponding to the prompt. For example, the prompt may provide or include context which may be used to answer the question, and the question module 220 may append a question to the prompt to generate an appended prompt, which may be provided as input to another model (e.g., the inference model 230). For example, when the compressed prompt is generated by the prompt compression model 210 as shown in FIG. 2, the question module 220 may generate an appended compressed prompt which includes the compressed prompt and the question, and may provide the appended compressed prompt as input to the inference model 230.

The inference model 230 may receive the appended prompt as input, and may process the appended prompt to obtain an inference result. For example, in some embodiments the prompt compression model 210 may be a large language model (LLM), but embodiments are not limited thereto. According to embodiments, the inference result may be, for example, an answer to the question. According to embodiments, the inference model 230 may correspond to the inference model 100 discussed above.

Accordingly, embodiments may provide an NL prompt encapsulation framework that may be used to effectively compress original prompts into compressed prompts. According to embodiments, the framework may be referred to as a nano-capsulator framework, and the compressed prompts may be referred to as capsule prompts. Embodiments may allow relatively long prompts to be compressed or encapsulated into relatively shorter prompts under specific generation length constraints, maintaining performance through an explicit unsupervised learning objective with reward scores. According to embodiments, the compressed prompts or capsule prompts may have a concise NL formatting which may preserve transferability and utility across diverse inference models. Accordingly, the compressed prompts or capsule prompts may provide many advantages, including the preservation of prompt transferability and utility, and the reduction of inference time and budget overheads. Embodiments may be used to effectively preserve utility of prompts and exhibit strong transferability across different inference models, enabling effective adaptation without retraining the prompt compression model 210.

According to embodiments, the compressed prompt may have many different uses. For example, embodiments may be used to compress a prompt used to perform chain-of-though (CoT) processing using a model such as an LLM. Rather than including specific steps or explicit examples, a CoT prompt may include one or more examples or demonstrations of problem solving, which may allow an inference model to infer the steps which are to be used to solve a problem or answer a question. Accordingly, CoT prompts may include multiple data samples and may be relatively long. Accordingly, embodiments may be used to shorten the CoT length effectively without sacrificing the performance of LLM inference.

In addition, when performing inferencing tasks such as question answering based on context (such as reading comprehension), the context provided to the LLMs may be relatively long. Accordingly, embodiments may allow a user to compress the prompt (and the context) to remove redundant information while ensuring that the relevant information is maintained, and inferencing performance is not degraded. In addition, embodiments may be used in other LLM-related tasks such as code generation, which may involve creating compressed NL representation of code rather than the code itself, or creating shorter code. For example, when the generation logic used for code generation is complex and uses or requires in-context learning with some examples and contexts in the prompt, the prompt may be compressed and optimized according to embodiments.

Although examples are described herein in which the prompt compression model 210, the question module 220, and the inference model 230 are included in the electronic device 200, embodiments are not limited thereto. For example, in some embodiments, one or more of the prompt compression model 210, the question module 220, and the inference model 230 may be included in a device which is separate from the electronic device 200, and which communicates with the electronic device 200. In addition, in some embodiments, the functions described with reference to the prompt compression model 210, the question module 220, and the inference model 230 may be performed by a single element or component which may be included in the electronic device 200, or which may be included in another device which communicates with the electronic device 200.

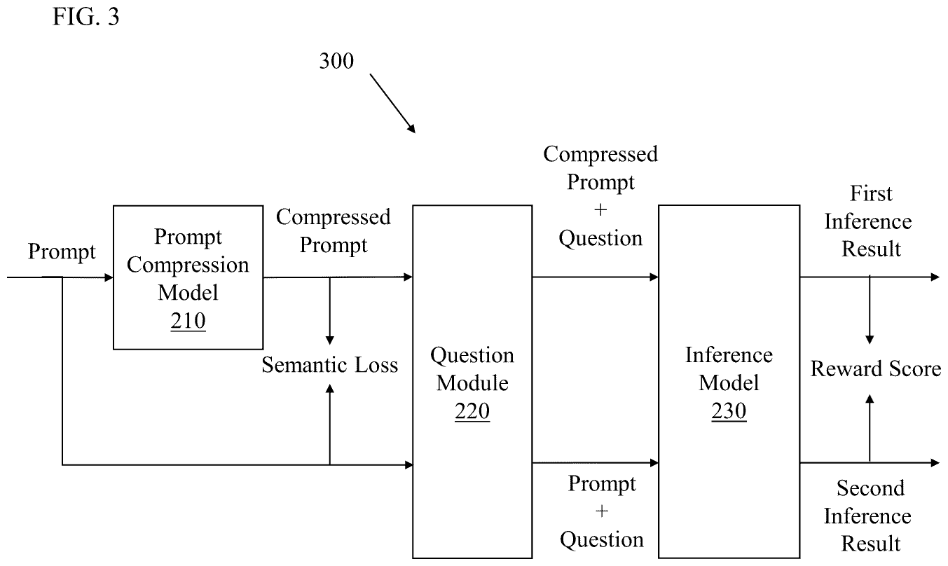

FIG. 3 is a diagram showing a training environment for training a prompt compression model, according to embodiments.

As shown in FIG. 3, the training environment 300 may include the prompt compression model 210, the question module 220, and the inference model 230. In some embodiments, the training environment 300 may be implemented using the electronic device 200, but embodiments are not limited thereto. For example, in some embodiments the prompt compression model 210 may be trained using a different device, for example a server, and may then be transferred or transmitted to the electronic device 200 to assist in performing inference tasks.

According to embodiments, the prompt compression model 210 may be trained to preserve the inherent utility of the original pre-compressed text (e.g., the original prompt) and also ensure that the compressed prompt closely reaches the designated length constraint. The learning or training of the prompt compression model 210 may involve integrating two components or training goals (e.g., NL-formatted prompt compression and prompt utility preservation) and optimizing them concurrently, thereby assuring that the compressed prompts are sufficient to preserve their inherent utility.

According to embodiments a straightforward, unsupervised training approach featuring semantic preservation loss may be used to motivate the model to compress contexts (e.g., prompts) while retaining similar semantic content. Relatively long prompts (e.g., the original prompts) may be shortened by summarizing their context and applying a semantic loss [symbol] _{Comp} to ensure maximal preservation of semantic meaning. According to embodiments, semantics may refer to the logical thinking process from a few-shot demonstration chain-of-thought (CoT) and beneficial content from context passages.

For example, the original prompt K={k₁, . . . kₙ} of n tokens may be compressed to the compressed prompt C={c₁, . . . cₘ} with m tokens, where n»m. The semantic loss may be used to ensure the maximal preservation by measuring the similarity between the hidden state embedding of C and K of the prompt compression model 210, which may be denoted as [symbol] (·|θ_{C}), where θ_{C} may denote a model parameter. In particular, a d-dimensional hidden state embedding of K and C can be generated by e_{K}˜ [symbol] (K|θ_{C}, T_{Rep}) and e_{C}˜ [symbol] (C|θ_{C}, Tₛᵤₘₘ), where T_{Rep} denotes a repeating instruction and Tₛᵤₘₘ denotes a summarizing instruction. Using T_{Rep}, the prompt compression model 210 [symbol] (·|θ_{C}) may be compelled to replicate the original prompt K under the model parameter θ_{C}, ensuring that e_{K}∈ [symbol] ^{d} accurately represents embedding of the original prompt K. Following this criterion, the prompt compression model 210 [symbol] (·|θ_{C}) may minimize the semantic loss function [symbol] _{Comp} according to Equation 1 below:

$${ℒ}_{Comp} = {𝔼}_{C} [ {D}_{dist} ( {e}_{K} ‖ {e}_{C} ) \qquad ( Equation 1 )$$

In Equation 1 above, D_{dist}(·∥·) may denote a distance measurement function in metric space. For example, in some embodiments, a mean square error may be used as the distance function D_{dist}(·∥·) to measure the similarity between e_{K} and e_{C}, but embodiments are not limited thereto.

To impose a constraint on the generated length while preserving utility, embodiments may also use a reward function [symbol] _{cap}(·) which may feature a strict cut-off mechanism Φ(·) to restrict the generated length of the capsule prompt (e.g., the compressed prompt C). The reward function may be used to calculate the score changes of the down-stream task question based on the original prompt K and the compressed prompt C. For example, the reward function [symbol] _{cap}(·) may use a truncation strategy to limit the compressed prompt C to a predetermined length before proceeding to compute the scores using the reward function [symbol] _{cap}(·). In this manner, a compressed prompt that surpasses the specified length threshold may be assigned a lower reward score as a result of the cut-off mechanism.

According to embodiments, given an inference model 230, which may be an arbitrary pretrained frozen LLM denoted [symbol] *(·), and a sampled set of downstream task questions Q, the reward function [symbol] _{cap}(·) may be expressed according to Equation 2 below:

$${ℛ}_{cap} = {𝔼}_{Q} [ I \{ 𝒢 ( Φ ( {C}_{i} ) ⊕ {Q}_{i} ) ‖ 𝒢 ( {K}_{i} ⊕ {Q}_{i} ) \} ] \qquad ( Equation 2 )$$

In Equation 2 above, I(·∥·) may denote a reward metric for yielding the reward score, and ⊕ may denote concatenation of prompts and questions. In some embodiments, the reward metric I(·∥·) may be, or may include, the mean square error between the hidden state embedding from the inference model 230 (e.g., the pretrained frozen LLM [symbol] *(·)). However, embodiments are not limited thereto, and in some embodiments the reward metric I(·∥·) may be, or may include, other metrics, such as accuracy and Rouge, which may facilitate its potential application to API-based LLMs.

Upon receiving the reward scores from the reward function [symbol] _{cap} using Equation 2, these scores may be synchronized or integrated with the semantic loss function [symbol] _{Comp} to maintain utility. Accordingly, an overall loss function [symbol] _{Nano} for training the prompt compression model 210 may be expressed according to Equation 3 below:

$${ℒ}_{Nano} = {ℒ}_{Comp} ( \cdot \vert {θ}_{C} ) * {ℛ}_{cap} ( \cdot \vert θ \text{*)} \qquad ( Equation 3 )$$

In Equation 3 above, θ* may denote the frozen model parameters of the inference model 230 (e.g., the LLM [symbol] *(·)) and θ_{C} may denote the trainable model parameters of the prompt compression model 210 (e.g., the model [symbol] (·|·)). According to embodiments, the overall loss function [symbol] _{Nano}(·) may impose penalties when shorter versions of compressed prompt exhibit inferior performance. This may mean that if a suboptimal compressed prompt receives a low reward score, its semantic loss optimization may include a high penalty value, which may result in a substantial loss value as a form of punishment during the training phase of the prompt compression model 210.

Accordingly, during the training of the prompt compression model 210, the semantic loss function [symbol] _{Comp} (e.g., as shown in Equation 1) may be used to preserve semantic meaning, and the reward function [symbol] _{cap}(e.g., as shown in Equation 2) may be used to maintain the utility of the compressed NL-formatted prompts. These elements or components may be integrated or aligned using the overall loss function [symbol] _{Nano} (e.g., as shown in Equation 3), and may be optimized simultaneously with the goal of obtaining compressed NL-formatted prompts of high utility.

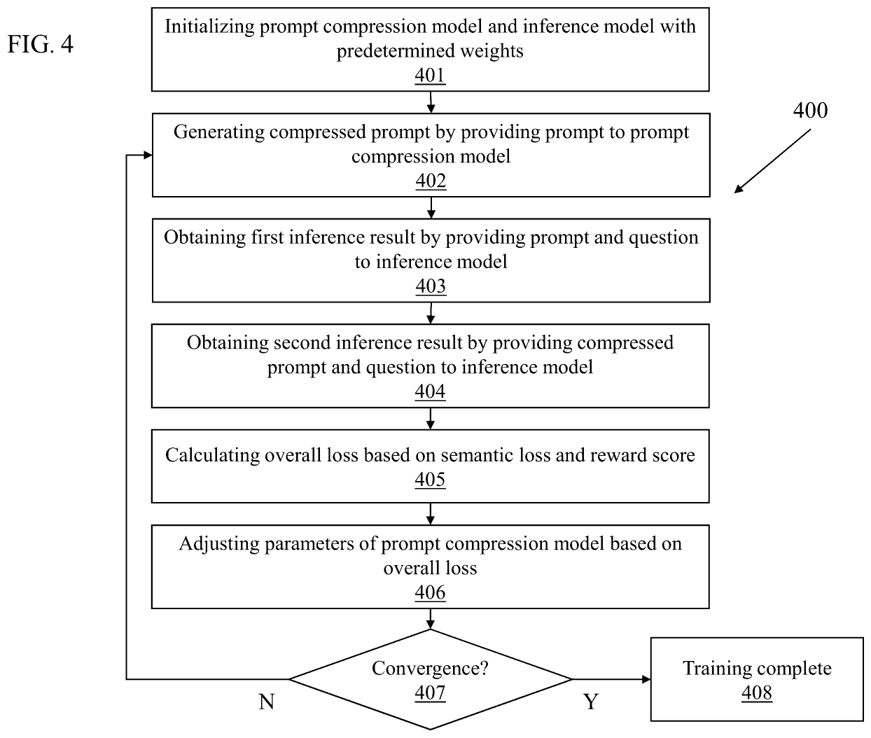

FIG. 4 is a flowchart illustrating a process for training a prompt compression model, according to embodiments.

At operation 401, the process 400 may include initializing the prompt compression model 210 and the inference model 230. In embodiments, the prompt compression model 210 and the inference model 230 may be initialized as predetermined or default models, for example models having predetermined or default parameters (e.g., weights and thresholds). According to embodiments, the inference model 230 may be frozen during the training of the prompt compression model 210, which may mean that the parameters (e.g., weights and thresholds) of the inference model 230 may be maintained (e.g., may be not adjusted or modified) during any of the operations included in the process 400.

At operation 402, the process 400 may include generating a compressed prompt by providing a prompt to the prompt compression model 210. In embodiments, the prompt may be an original prompt that is included in training data used to perform the training during the process 400. For example, according to embodiments, the training data may include original prompts along with corresponding questions to be appended to the original prompts.

At operation 403, the process 400 may include obtaining a first inference result by providing the compressed prompt and a corresponding question to the inference model 230. In some embodiments, operation 403 may include providing the compressed prompt to the question module 220, which may append the question to the compressed prompt to obtain an appended compressed prompt, and then providing the appended compressed prompt as input to the inference model 230 to obtain the first inference result.

At operation 404, the process 400 may include obtaining a second inference result by providing the prompt and the corresponding question to the inference model 230. For example, the prompt may correspond to the original prompt discussed above. In some embodiments, operation 404 may include providing the prompt to the question module 220, which may append the question to the prompt to obtain an appended prompt, and then providing the appended prompt as input to the inference model 230 to obtain the second inference result.

At operation 405, the process 400 may include calculating an overall loss based on a semantic loss and a reward score. For example, the semantic loss may be determined based on the prompt and the compressed prompt. In embodiments, the semantic loss may correspond to the semantic loss function [symbol] _{Comp} discussed above, and may be determined according to Equation 1. In addition, the reward score may be determined based on the first inference result and the second inference result. In embodiments, the reward score may correspond to the reward function [symbol] _{cap} discussed above, and may be determined according to Equation 2. Further, the overall loss may correspond to the overall loss function [symbol] _{Nano} discussed above, and may be determined according to Equation 3.

At operation 406, the process 400 may include adjusting parameters of prompt compression model 210 based on the overall loss. In embodiments, the adjusting of the parameters may include adjusting at least one of weights and thresholds included in, corresponding to, or associated with the prompt compression model 210. As discussed above, the inference model 230 may be frozen during the training of the prompt compression model 210, so parameters (e.g., weighs and thresholds) of the inference model 230 may be maintained (e.g., may be not adjusted or modified) during operation 406.

At operation 407, the process 400 may include determining whether the training of the prompt compression model 210 is completed. For example, operation 407 may include determining whether convergence has occurred for the prompt compression model 210. In embodiments, convergence may occur when the prompt compression model 210 achieves a state during training in which the loss (e.g., the overall loss computed using the overall loss function [symbol] _{Nano}) settles to within a predetermined error range with respect to the training data, but embodiments are not limited thereto.

Based on determining that the training of the prompt compression model 210 is completed (Y at operation 407), the process 400 may proceed to operation 408, and the process 400 may end. Based on determining that the training of the prompt compression model 210 is not completed (N at operation 407), the process 400 may return to operation 402 and begin another training iteration.

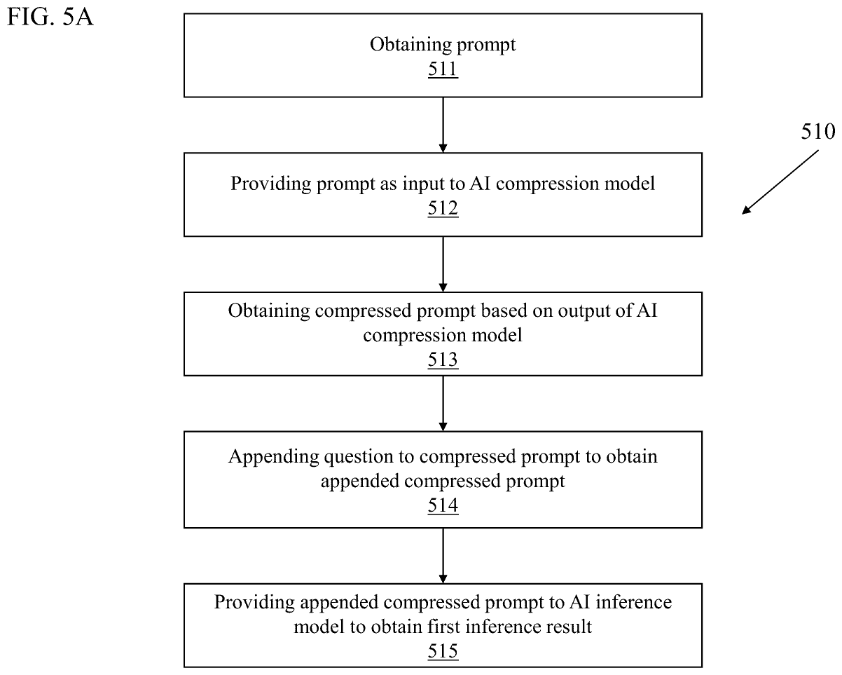

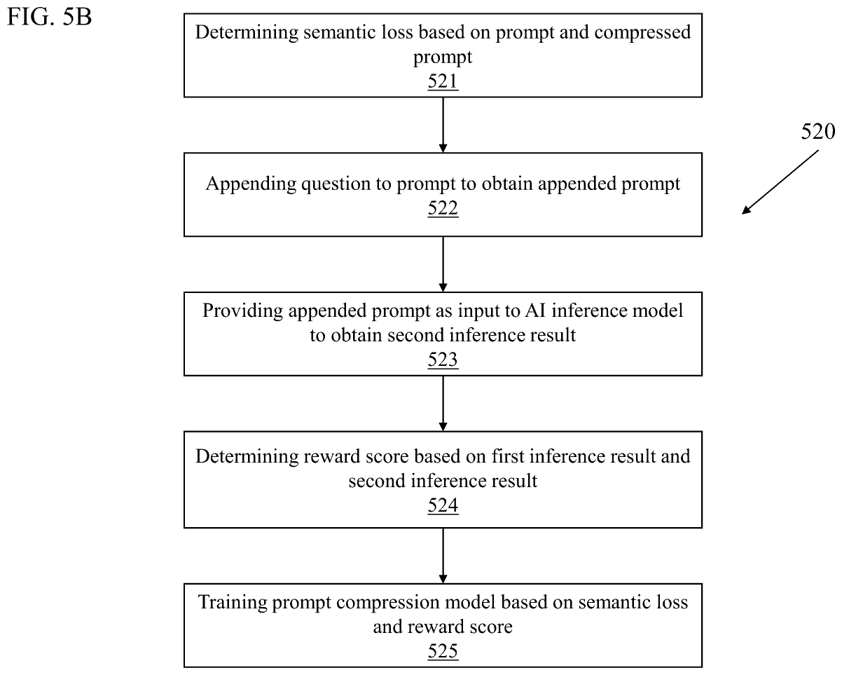

FIGS. 5A and 5B are flowcharts illustrating processes for training and using a prompt compression model, according to embodiments.

FIG. 5A is a flowchart of a process for obtaining inference results using a compressed prompt generated by a prompt compression model, according to embodiments. In embodiments, the process 510 illustrated in FIG. 5A may be performed by any of the elements discussed above, for example at least one of the electronic device 200 and any of the components or elements included therein.

At operation 511, the process 510 may include obtaining a prompt for an artificial intelligence (AI) inference model. In embodiments, the prompt may be expressed in an NL format. In some embodiments, the prompt may be a chain of thought prompt including a plurality of questions and a corresponding plurality of answers. The prompt may correspond to a first plurality of tokens. The prompt may correspond to the original prompt discussed above. The AI inference model may correspond to at least one of the inference model 100 and the inference model 230 discussed above. In some embodiments, the AI inference model may be an LLM. The prompt may include context which is to be used by the AI inference model, in order to generate an inference result corresponding to a question.

At operation 512, the process 510 may include providing the prompt as an input to an AI compression model. In embodiments, the AI compression model may correspond to the prompt compression model 210 discussed above. In some embodiments, the AI compression model may be an LLM.

At operation 513, the process 510 may include obtaining a compressed prompt based on an output of the AI compression model. In embodiments, the prompt may be expressed in an NL format. The compressed prompt may correspond to a second plurality of tokens which is smaller than the first plurality of tokens. For example, in some embodiments a number of the second plurality of tokens may be less than a predetermined maximum number of tokens for the AI compression model. The compressed prompt may correspond to the compressed prompt discussed above.

At operation 514, the process 510 may include appending a question to the compressed prompt to obtain an appended compressed prompt.

At operation 515, the process 510 may include providing the appended compressed prompt to the AI inference model to obtain a first inference result.

FIG. 5B is a flowchart of a process for training a prompt compression model, according to embodiments. In embodiments, the process 520 illustrated in FIG. 5B may be performed by any of the elements discussed above, for example at least one of the electronic device 200 and any of the components or elements included therein. In embodiments, one or more operations of the process 520 may be performed after or in combination or cooperation with one or more operations of the process 510 discussed above.

At operation 521, the process 520 may include determining semantic loss based on prompt and compressed prompt. In embodiments, the semantic loss may correspond to the semantic loss function [symbol] _{Comp} discussed above, and may be determined according to Equation 1. In embodiments, operation 521 may include obtaining a first embedding representing the prompt and a second embedding representing the compressed prompt and determining a semantic loss between the first embedding and the second embedding.

At operation 522, the process 520 may include appending the question to the prompt to obtain an appended prompt.

At operation 523, the process 520 may include providing the appended prompt to the AI inference model to obtain a second inference result.

At operation 524, the process 520 may include determining a reward score based on the first inference result and the second inference result. In embodiments, the reward score may correspond to the reward function [symbol] _{cap} discussed above, and may be determined according to Equation 2.

At operation 525, the process 520 may include training the AI compression model based on at least one of the semantic loss and the reward score. For example, the process may include determining an overall loss based on at least one of the semantic score and the reward score, and then training the AI compression model based on the overall loss. In embodiments, the training may include changing one or more parameters (e.g., one or more weights or thresholds) of the AI compression model to reduce or minimize the overall loss. In embodiments, the overall loss may correspond to the overall loss function [symbol] _{Nano} discussed above, and may be determined according to Equation 3. In embodiments, the AI inference model may be frozen during the training.

Accordingly, embodiments may provide a prompt compression model which may be used to compress a relatively long original prompt to obtain a relatively short compressed prompt. In comparison with the original long prompt, the compressed prompt may allow for improved processing efficiency and reduced resource requirements when provided to a downstream inference model such as the AI inference model discussed above. In addition, the short prompt output by the prompt compression model may be in an NL format. As a result, the prompt compression model and the compressed prompt may be usable by inference models which are different from the AI inference model discussed above, for example different LLMs or different types of inference models.

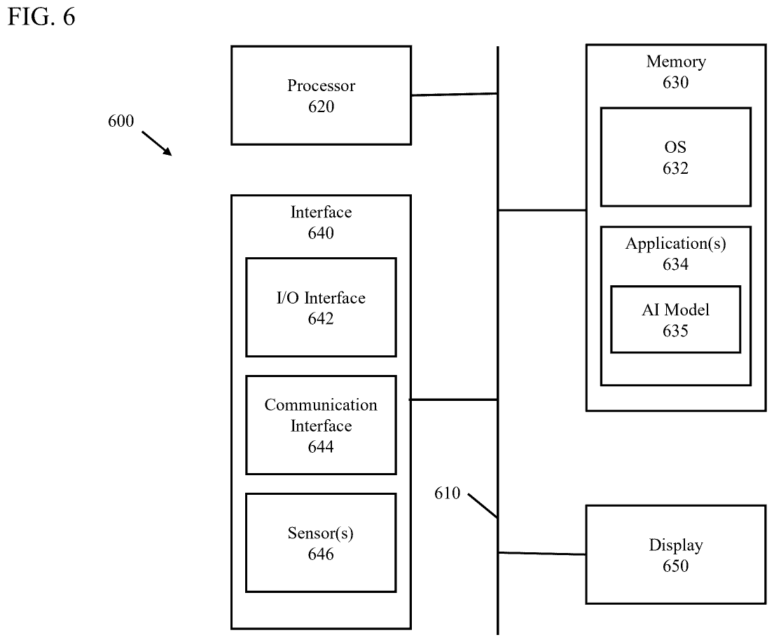

FIG. 6 is a block diagram of an electronic device according to embodiments

FIG. 6 is for illustration only, and other embodiments of the electronic device 600 could be used without departing from the scope of this disclosure. For example, the electronic device 600 may correspond to at least one of the electronic device 200 and any of the elements or components included therein.

The electronic device 600 includes a bus 610, a processor 620, a memory 630, an interface 640, and a display 650.

The bus 610 includes a circuit for connecting the components 620 to 650 with one another. The bus 610 functions as a communication system for transferring data between the components 620 to 650 or between electronic devices.

The processor 620 includes one or more of a central processing unit (CPU), a graphics processor unit (GPU), an accelerated processing unit (APU), a many integrated core (MIC), a field-programmable gate array (FPGA), or a digital signal processor (DSP). The processor 620 is able to perform control of any one or any combination of the other components of the electronic device 600, and/or perform an operation or data processing relating to communication. For example, the processor 620 may perform operations of the processes 400, 510, and 520 illustrated in FIGS. 4 and 5A-5B. The processor 620 executes one or more programs stored in the memory 630.

The memory 630 may include a volatile and/or non-volatile memory. The memory 630 stores information, such as one or more of commands, data, programs (one or more instructions), applications 634, etc., which are related to at least one other component of the electronic device 600 and for driving and controlling the electronic device 600. For example, commands and/or data may formulate an operating system (OS) 632. Information stored in the memory 630 may be executed by the processor 620.

The applications 634 include the above-discussed embodiments. These functions can be performed by a single application or by multiple applications that each carry out one or more of these functions. For example, the applications 634 may include artificial intelligence (AI) models for performing operations of the processes 400, 510, and 520 illustrated in FIGS. 4 and 5A-5B, for example one or more of the inference model 100, the prompt compression model 210, and the inference model 230. Specifically, the applications 634 may include at least one of inference model 100, the prompt compression model 210, the question module 220, and the inference model 230, according to embodiments of the disclosure.

The display 650 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 640 includes input/output (I/O) interface 642, communication interface 644, and/or one or more sensors 646. The I/O interface 642 serves as an interface that can, for example, transfer commands and/or data between a user and/or other external devices and other component(s) of the electronic device 600.

The communication interface 644 may include a transceiver to enable communication between the electronic device 600 and other external devices (e.g., a sensor node or a fusion center), via a wired connection, a wireless connection, or a combination of wired and wireless connections. The communication interface 644 may permit the electronic device 600 to receive information from another device and/or provide information to another device. For example, the communication interface 644 may include an Ethernet interface, an optical interface, a coaxial interface, an infrared interface, a radio frequency (RF) interface, a universal serial bus (USB) interface, a Wi-Fi interface, a cellular network interface, or the like.

The transceiver of the communication interface 644 may include a radio frequency (RF) circuitry and a baseband circuitry.

The baseband circuitry may transmit and receive a signal through a wireless channel, and may perform band conversion and amplification on the signal. The RF circuitry may up-convert a baseband signal provided from the baseband circuitry into an RF band signal and then transmits the converted signal through an antenna, and down-converts an RF band signal received through the antenna into a baseband signal. For example, the RF circuitry may include a transmission filter, a reception filter, an amplifier, a mixer, an oscillator, a digital-to-analog converter (DAC), and an analog-to-digital converter (ADC).

The transceiver may be connected to one or more antennas. The RF circuitry of the transceiver may include a plurality of RF chains and may perform beamforming. For the beamforming, the RF circuitry may control a phase and a size of each of the signals transmitted and received through a plurality of antennas or antenna elements. The RF circuitry may perform a downlink multi-input and multi-output (MIMO) operation by transmitting one or more layers.

The baseband circuitry may perform conversion between a baseband signal and a bitstream according to a physical layer standard of the radio access technology. For example, when data is transmitted, the baseband circuitry generates complex symbols by encoding and modulating a transmission bitstream. When data is received, the baseband circuitry reconstructs a reception bitstream by demodulating and decoding a baseband signal provided from the RF circuitry.

The sensor(s) 646 of the interface 640 can meter a physical quantity or detect an activation state of the electronic device 600 and convert metered or detected information into an electrical signal. For example, the sensor(s) 646 can include one or more cameras or other imaging sensors for capturing images of scenes. The sensor(s) 646 can also include any one or any combination of a microphone, a keyboard, a mouse, and one or more buttons for touch input. The sensor(s) 646 can further include an inertial measurement unit. In addition, the sensor(s) 646 can include a control circuit for controlling at least one of the sensors included herein. Any of these sensor(s) 646 can be located within or coupled to the electronic device 600.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 600, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device 600.

A model related to the neural networks described above may be implemented via a software module. When the model is implemented via a software module (for example, a program module including instructions), the model may be stored in a computer-readable recording medium.

Also, the model may be a part of the electronic device 600 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method of performing natural language prompt compression, the method comprising:
obtaining a prompt for an artificial intelligence (AI) inference model, wherein the prompt corresponds to a first plurality of tokens;
providing the prompt as an input to an AI compression model; and
obtaining a compressed prompt based on an output of the AI compression model,
wherein the compressed prompt corresponds to a second plurality of tokens which is smaller than the first plurality of tokens, and
wherein the prompt and the compressed prompt are expressed using natural language.

2. The method of claim 1, further comprising:
obtaining a first embedding representing the prompt and a second embedding representing the compressed prompt;
determining a semantic loss between the first embedding and the second embedding; and
training the AI compression model based on the semantic loss.

3. The method of claim 1, further comprising:
appending a question to the compressed prompt to obtain an appended compressed prompt; and
providing the appended compressed prompt to the AI inference model to obtain a first inference result.

4. The method of claim 3, further comprising:
appending the question to the prompt to obtain an appended prompt;
providing the appended prompt to the AI inference model to obtain a second inference result;
determining a reward score based on the first inference result and the second inference result; and
training the AI compression model based on the reward score.

5. The method of claim 4, wherein parameters of the AI inference model are frozen during the training of the AI compression model.

6. The method of claim 1, wherein the AI compression model and the AI inference model are large language models (LLMs).

7. The method of claim 1, wherein the prompt is a chain of thought prompt comprising a plurality of questions and a corresponding plurality of answers.

8. The method of claim 1, wherein a number of the second plurality of tokens is less than a maximum number of tokens for the AI compression model.

9. An electronic device for performing natural language prompt compression, the electronic device comprising:
at least one memory configured to store instructions; and
at least one processor configured to execute the instructions to:
obtain a prompt for an artificial intelligence (AI) inference model, wherein the prompt corresponds to a first plurality of tokens,
provide the prompt as an input to an AI compression model, and
obtain a compressed prompt based on an output of the AI compression model,
wherein the compressed prompt corresponds to a second plurality of tokens which is smaller than the first plurality of tokens, and
wherein the prompt and the compressed prompt are expressed using natural language.

10. The electronic device of claim 9, wherein the at least one processor is further configured to execute the instructions to:
obtain a first embedding representing the prompt and a second embedding representing the compressed prompt;
determine a semantic loss between the first embedding and the second embedding; and
train the AI compression model based on the semantic loss.

11. The electronic device of claim 9, wherein the at least one processor is further configured to execute the instructions to:
append a question to the compressed prompt to obtain an appended compressed prompt; and
provide the appended compressed prompt to the AI inference model to obtain a first inference result.

12. The electronic device of claim 11, wherein the at least one processor is further configured to execute the instructions to:
append the question to the prompt to obtain an appended prompt;
provide the appended prompt to the AI inference model to obtain a second inference result;
determine a reward score based on the first inference result and the second inference result; and
train the AI compression model based on the reward score.

13. The electronic device of claim 12, wherein parameters of the AI inference model are frozen during the training of the AI compression model.

14. The electronic device of claim 9, wherein the AI compression model and the AI inference model are large language models (LLMs).

15. The electronic device of claim 9, wherein the prompt is a chain of thought prompt comprising a plurality of questions and a corresponding plurality of answers.

16. The electronic device of claim 9, wherein a number of the second plurality of tokens is less than a maximum number of tokens for the AI compression model.

17. A non-transitory computer-readable medium storing instructions which, when executed by at least one processor of a device for performing natural language prompt compression, cause the device to:
obtain a prompt for an artificial intelligence (AI) inference model, wherein the prompt corresponds to a first plurality of tokens;
provide the prompt as an input to an AI compression model; and
obtain a compressed prompt based on an output of the AI compression model;
wherein the compressed prompt corresponds to a second plurality of tokens which is smaller than the first plurality of tokens, and
wherein the prompt and the compressed prompt are expressed using natural language.

18. The non-transitory computer-readable medium of claim 17, wherein the instructions further cause the device to:
obtain a first embedding representing the prompt and a second embedding representing the compressed prompt;
determine a semantic loss between the first embedding and the second embedding; and
train the AI compression model based on the semantic loss.

19. The non-transitory computer-readable medium of claim 17, wherein the instructions further cause the device to:
append a question to the compressed prompt to obtain an appended compressed prompt; and
provide the appended compressed prompt to the AI inference model to obtain a first inference result.

20. The non-transitory computer-readable medium of claim 19, wherein the instructions further cause the device to:
append the question to the prompt to obtain an appended prompt;
provide the appended prompt to the AI inference model to obtain a second inference result;
determine a reward score based on the first inference result and the second inference result; and
train the AI compression model based on the reward score.
